(19) United States
(12) Patent Application Publication
(10) Pub. No.: US 2015/0188205 A1
(43) Pub. Date: Jul. 2, 2015

(54) Case-Cooled Potted Battery Fixture

(71) Applicants: Jeffrey A. Polochak, Pittsburgh, PA (US); Logan M. Compton, Fredericksburg, VA (US)

(72) Inventors: Jeffrey A. Polochak, Pittsburgh, PA (US); Logan M. Compton, Fredericksburg, VA (US)

(73) Assignee: CHIEF OF NAVAL RESEARCH, OFFICE OF COUNSEL, Arlington, VA (US)

(21) Appl. No.: 14/576,390

(22) Filed: Dec. 19, 2014

Related U.S. Application Data
(60) Provisional application No. 61/922,615, filed on Dec. 31, 2013.

(51) Int. Cl. H01M 10/6567; H01M 2/10

(52) U.S. Cl. CPC H01M 10/6567; H01M 10/613; H01M 10/643; H01M 10/655; H01M 2/1077; H01M 2/105

(57) ABSTRACT

A design and process are provided for thermal management of electrical batteries. The potted case-cooled battery fixture operates for a plurality of batteries disposed in holes bored in a thermally conductive housing. The batteries are disposed in each of the holes of a case and a thermal epoxy is disposed in the space between the inside of the hole and the outer case of the batteries. The resulting fixture creates a thermally conductive casing that encapsulates the battery's circumference and minimizes the thermal resistance between the battery and the thermally conductive housing, thus maximizing heat transfer from the battery through the housing. The potted case-cooled battery fixture is capable of being sufficiently rugged, both electrically and mechanically, capable of being easily manufactured and mass produced, and proficient of effectively cooling heated batteries to a prescribed temperature within an allotted time.

### CROSS REFERENCE TO RELATED APPLICATION

Pursuant to 35 U.S.C. §119, the benefit of priority from provisional application 61/922,615, with a filing date of Dec. 31, 2013, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention generally relates to thermal management. In particular, the invention relates to methods and apparatus for thermally managing battery systems while minimizing their physical footprint and maintaining their ruggedness.

Conventionally, there exist two varying approaches to manage battery temperature while minimizing the physical footprint and increasing the ruggedness of the cells packaging to survive a shipboard environment. These two conventional approaches are referred to as the end and case-cooling approaches. The batteries are arranged in multicellular packs, typically in a matrix arrangement. A cold plate or heat sink is constrained to be located only on one end (bottom of the packs) to cool the batteries due to volume requirements. The difference between the two cooling approaches is on how they draw the heat out from the battery cores and transfer the energy into the cold plates.

FIG. 1 shows an isometric view 100 of a conventional battery case assembly 110. A series of four batteries 120 are disposed between thermally conductive end clamps 130 with an electrically resistive layer 140 and a gap-pad 150 therebetween. The clamps 130 are mounted to a thermal heat sink 160 as a base. View 100 features an end-cooling approach that absorbs heat through the ends of the batteries 120 into the clamps 130 that are separated by the insulation layer 140, such as Kapton®, and a thermally conductive gap pad 150. The end clamps 130 can transfer the heat into a heat sink 160. The end clamps 130, which are typically made from aluminum, also serve to constrain the batteries 120 from movement when the battery stacks are in place.

FIG. 2 shows an isometric view 200 regarding the second thermal management approach for a battery assembly 210, in particular a case-cooling method. Four batteries 220 are disposed abreast between a thermally conductive case 230 divided bilaterally and joined together at bottom by a heat sink 240 and at top by a clamp 250. The case 230 envelopes the batteries 220 to remove heat radially therefrom. A combined layer of electrical insulation with a thermally conductive gap pad 260 can electrically isolate the batteries 220 from the case 230 and aid in conducting thermal energy from the batteries 220 into the case 230, transferring that energy into the heat sink 240. The clamp 250 can hold two halves of the case 230 together. Each battery 220 includes a central anode 270 and an annular cathode 280 along the same axial end.

The end-cooling process in view 100 has limitations that are undesirable for packing, manufacturing and effective cooling. Beginning with the packaging limitation of the end clamp method, the clamps that are drawing heat are also at the same location as the electrical leads. The end clamp configuration poses an electrical risk from shorting the anode to the cathode of the battery through the clamp on the anode side of the battery. This risk is even more probable during assembly or due to high impulsive external force, such as a drop or nearby explosion. The manufacturing costs will be increased due to manual assembly processes and increased risk during packaging.

The end-cooling process in view 100 also suffers from thermal limitations, as the heat must transfer through the narrow thermal area at the ends of the batteries. In some embodiments, this area can be about 5.7 cm². Although the thermal conductivity of the battery is about ten times (an order of magnitude) greater in the axial direction than in the radial direction, the area to remove the heat in the axial direction is about 8.4 times less than in the radial direction.

The difficulty with the case-cooling method of cooling in view 200 is that fabricating and assembling can be cumbersome, requiring the appropriate application of the thermal pad for adequate thermal contact. The fabrication involves a solid block of thermally conductive material, such as aluminum, which is drilled and them bored to a nonstandard hole size. Then, the block is cut length-wise to create two separate thermally conductive holes.

The main difficulty is that the contact pressure between the clamps and the batteries will not be uniform, especially at the center portion where the clamps are not fixed. The geometry encompassing the batteries is narrow enough to deform sufficiently to inadequately apply appropriate contact pressure. Typically, an aluminum alloy must be used to help alleviate deformities. The contact pressure relief will yield in reduced thermal performance of the system due to more probably air asperities.

### SUMMARY

As can be seen, there is a need for a battery cooling apparatus and accompanying method that can effectively cool a battery system while avoiding the pitfalls of the conventional apparatus. Conventional cooling techniques for battery assemblies yield disadvantages addressed by various exemplary embodiments of the present invention. In particular, battery fixture for thermal management of a set of electrical batteries.

The exemplary fixture includes a thermally conductive housing; a plurality of holes formed through the housing; a spacing member concentrically disposing each battery in a respective hole; and thermal epoxy disposed between an inner hole surface and an outer battery surface. Other various embodiments alternatively or additionally provide for molds for enabling injection of the epoxy into the holes via cups corresponding to the ends of the batteries.

In another aspect of the present disclosure, a method for cooling a plurality of batteries comprises centering, with a spacing member, a plurality of batteries in a plurality of holes formed through a thermally conductive housing; and filling a space formed between the inner surface of the plurality of holes and the outer surface of the batteries with a thermal epoxy. These and other features, aspects and advantages of the present invention will become better understood with reference to the following drawings, description and claims.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a perspective view illustrating a conventional end-cooling method;

FIG. 2 is a perspective view illustrating a conventional case-cooling method;

FIGS. 3A and 3B are exemplary schematic battery cross-sections respectively illustrating radial and axial volumetric heat generation;

FIG. 3C is a dimensional table of battery characteristics;

FIG. 4 is a graph illustrating axial versus radial heat generation;

FIG. 5 is a graph illustrating conceptual axial versus radial change in temperature;

FIG. 6 is a two-dimensional grid representation of the battery and case;

FIGS. 7 and 8 are response graphs showing transient core temperature;

FIG. 9 is a graph illustrating an experimental comparison between end and case-cooling;

FIG. 10 is a graph illustrating effective heat transfer coefficients;

FIG. 11 is a perspective explosive view of components for a potted case;

FIG. 12 is a perspective assembly view of a case-cooled battery pack;

FIG. 13 is a perspective view of an injection mold;

FIGS. 14A and B are plan and detail views of the mold from the exposed face;

FIG. 15A is an elevation cross-section view of the mold;

FIG. 15B is a perspective detail view of the mold and epoxy conduits;

FIG. 16 is an exploded perspective view for installing the case-cooled battery pack with the molds;

FIGS. 17A and 17B are perspective and elevation cross-section views of the case-cooled battery pack with the molds;

FIG. 18 is an exploded perspective view with gasket rings centering the batteries into holes formed in the thermally conductive housing for an alternative configuration;

FIGS. 19A and 19B are perspective views of the case-cooled battery pack;

FIG. 20 is a perspective view of the case-cooled battery pack with shims; and

FIGS. 21A and 21B are perspective views of the case-cooled battery pack with an epoxy injection mechanism.

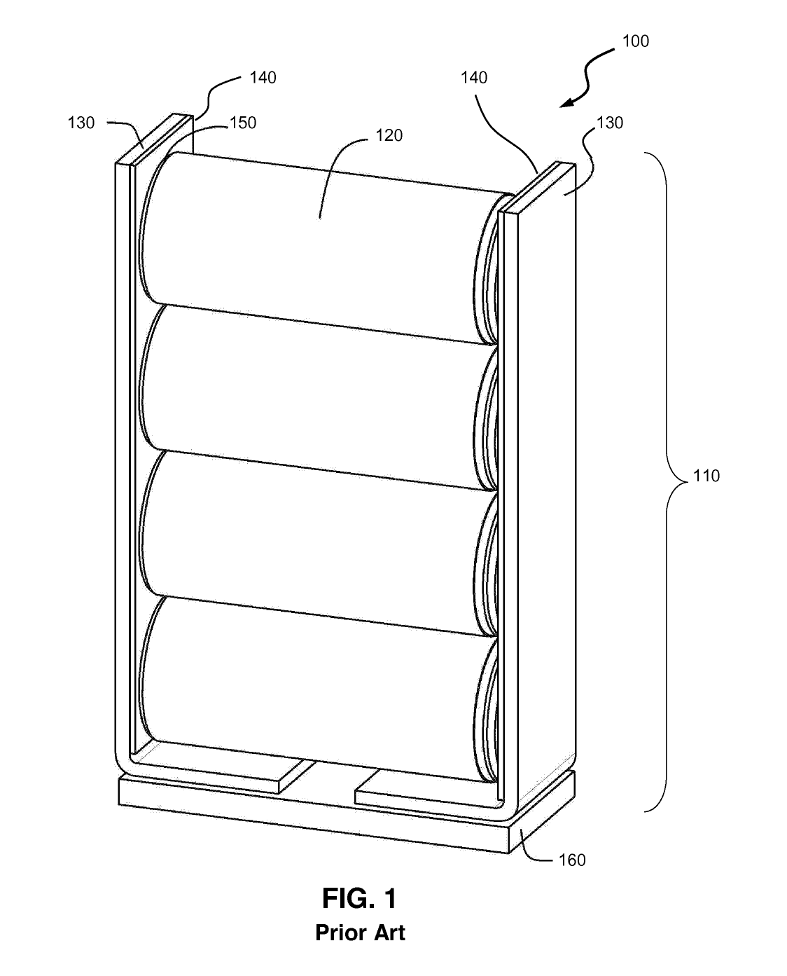

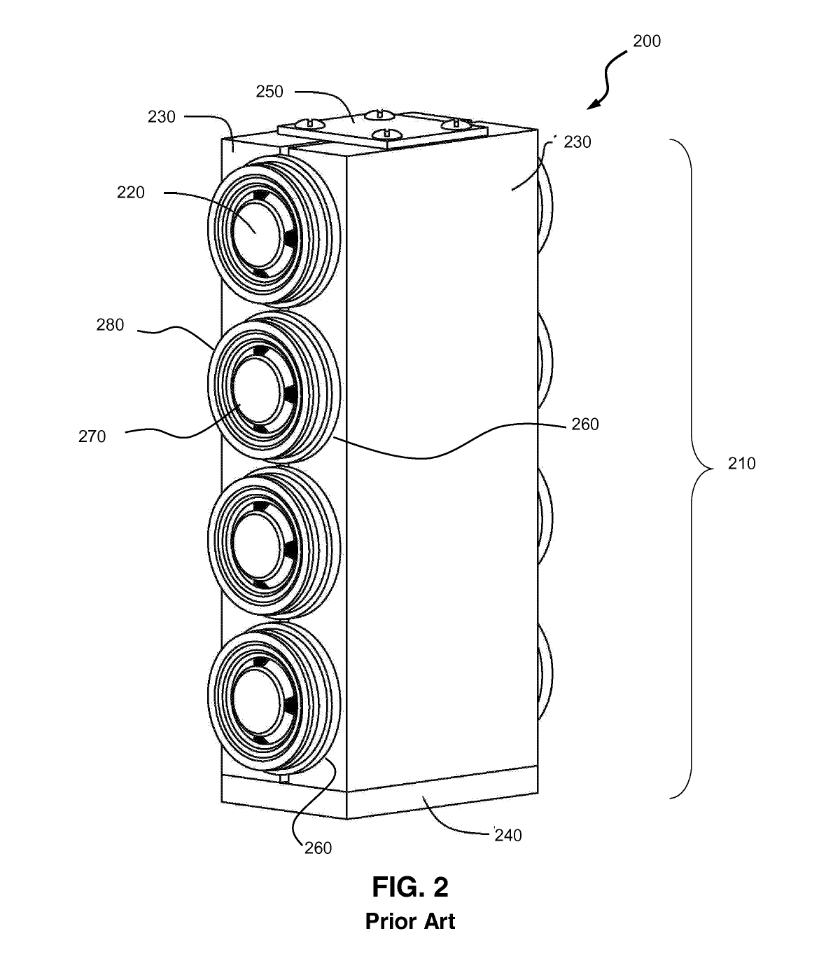

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Exemplary embodiments generally relate to a potted case-cooled battery fixture as providing the process of choice for thermal management of a battery system. A plurality of batteries may be disposed in holes bored in a thermally conductive housing. The batteries are centrically disposed in each of the holes and a thermally conductive adhesive (e.g., epoxy) is disposed in the void between the inside of the hole and the outer case of the batteries. Example adhesives include TC-2707 and TC-2810 from 3M Company in St. Paul, Minn.

The resulting fixture creates a thermally conductive casing that encapsulates the battery's circumference and minimizes the thermal resistance between the battery and the thermally conductive housing, thus maximizing heat transfer from the battery through the housing. The potted case-cooled battery fixture is capable of being sufficiently rugged, both electrically and mechanically, capable of being easily manufactured and mass produced, and proficient of effectively cooling heated batteries to a prescribed temperature within an allotted time. Prior to determining one or more designs for a battery cooling apparatus, an analytical cooling comparison was performed.

The larger radial surface area and shorter heat conduction paths play a large factor in effectively removing the generated heat in the radial direction or a battery as compared to the axial direction of the battery. The heat generated within the battery cell is due to volumetric heating as the radial distance from the center increases the volume parabolically in the radial direction, therefore the heat generated also increases parabolically.

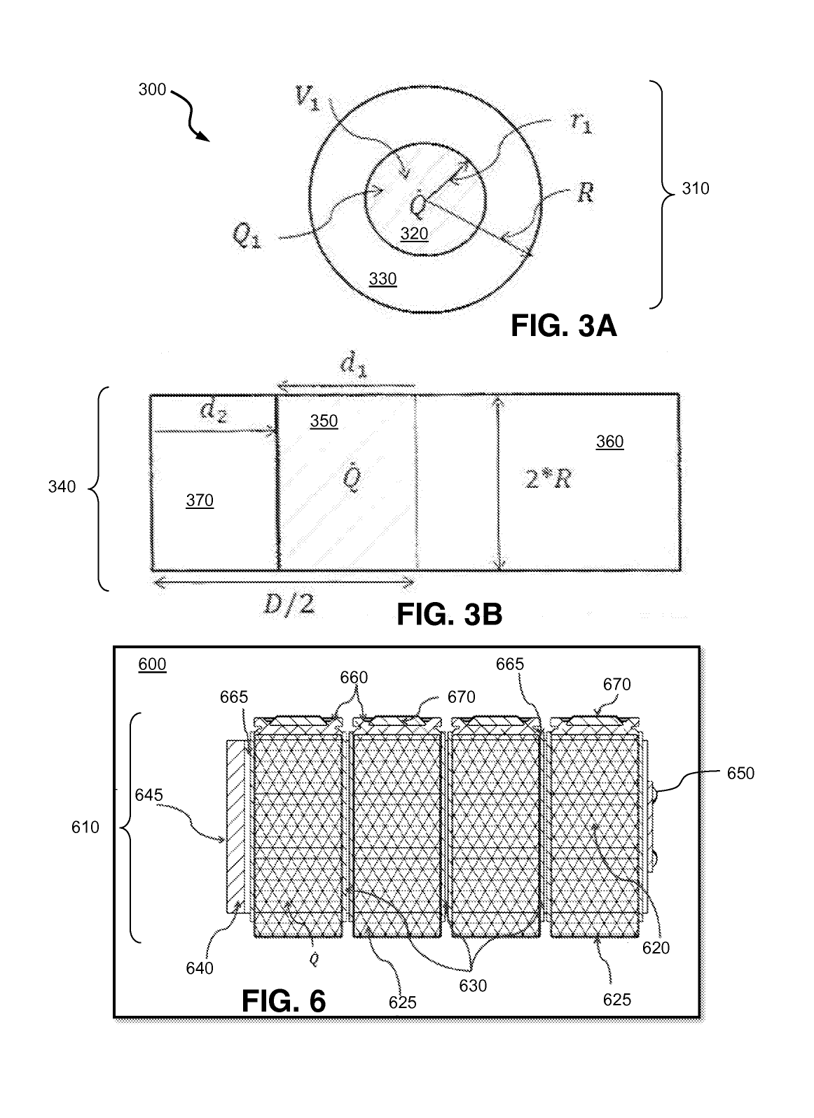

FIGS. 3A and 3B show two-dimensional cross-sectional views 300 of volumetric heat generation in both the radial and axial directions of a cylindrical shape that describes a battery 220 and annular housing. The radial cross-section assembly 310 includes a radial heat generation area 320 and an annular area periphery 330. The axial cross-section assembly 340 includes an axial heat generation area 350 and annular peripheries 360 and 370 radially extending from the centerline. The volumetric heat generation quantities are determined by radius R and diameter D. Transient heat generation \dot{Q}=dQ/dt (watts per second) extends from a center core both in the radial direction r₁ and axial direction d₁. Heat transfers from the battery 220 radially at 0.1 W/mK and axially at 1 W/mK. The central anode 270 has a surface area off 1.1 cm², whereas the annular cathode 280 employ tabs with 0.065 cm². The cylindrical area of the battery 220 is about 48 cm².

The total radial heat Qᵣ (watts) that is produced in the radial direction exhibits a parabolic growth with respect to the radius r₁ which concludes that over half of the heat produced (3.5 W) is over half the distance (71%) to the outer shell. However, if the total axial heat Qₐ is transferred in the axial direction d₁, over half of the heat produced (3.5 W) is exactly half the distance (50%) to the outer cap. The relations can be expressed by eqns. 1 and 2 for the respective radial and axial cross-sections 310 and 340.

Qᵣ=qπr₁²2D, (1)

Qₐ=qπR²2d₁. (2)

The reduced conduction distance of the bulk heat generated further improves heat transfer in the radial direction. Even though the radially thermal conduction is worse than the axial thermal conduction, the majority of the heat generation in the radial direction does not travel as far as the majority of the heat traveling in the axial direction.

FIG. 3C provides a tabular view 380 that includes Table 1 for dimensions and quantities related to heat dissipation. To effectively quantify the performance characteristics of the two thermal cooling schemes, the metric uses the change in temperature from a predetermined distance within the battery to the outer barrier of the battery. To conceptually understand the difference between the two scenarios, a steady state one-dimensional conduction heat transfer model was used while solving for temperature difference, ΔT to produce the following relations between the outer shell and a point r₁ for the radial case, and between the end cap and a point d₂ for the axial case:

$$\begin{matrix}Δ {T}_{a} = \frac{{d}_{2} {Q}_{a}}{{k}_{a} π {R}^{2}} , & ( 3 ) \\ Δ {T}_{r} = \frac{ln ( R / {r}_{1} ) {Q}_{r}}{2 π {Dk}_{r}} . & ( 4 )\end{matrix}$$

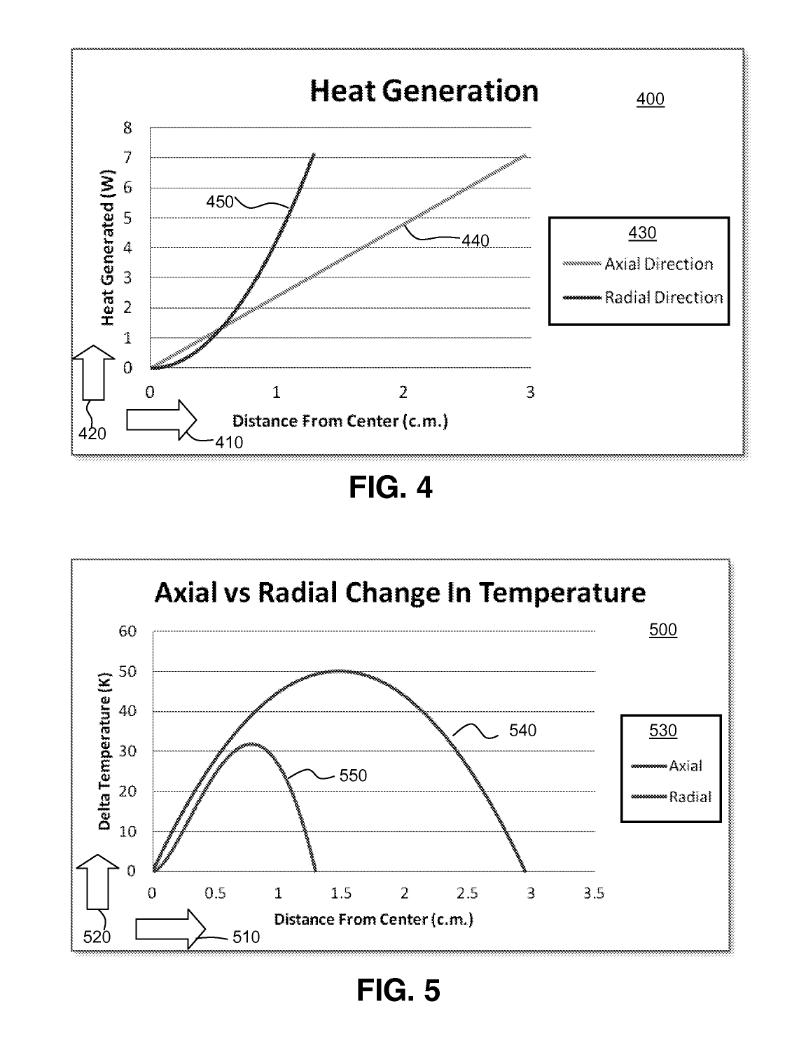

FIG. 4 shows a graphical view 400 of heat generation in relation to distance from the center of a battery 220. Distance from center in centimeters represents the abscissa 410 and heat generation in Watts represents the ordinate 420. A legend 430 identifies the plotted curves for axial 440 and radial 450 directions.

FIG. 5 shows a graphical view 500 of temperature difference in relation to distance from the center. Distance from center in centimeters represents the abscissa 510 and temperature difference in Kelvins represents the ordinate 520. A legend 530 identifies the plotted curves for axial 540 and radial 550 directions.

FIG. 6 shows a plan mesh view 600 of an exemplary two-dimensional numerical model 610. Representations of four batteries 620 abreast are shown with a graphite base 625 at the cathode and separated by aluminum 6061 thermal pad 630 further overlaid by a Kapton gap pad 635. An aluminum 6061 heat sink 640 is disposed at one end set to a constant temperature 645. A clamp 650 is disposed opposite the heat sink 640. Flanges 660 composed of 304-stainless steel that enclose air chambers 665 are disposed on the batteries 620 around the anode 670 opposite the graphite base 625.

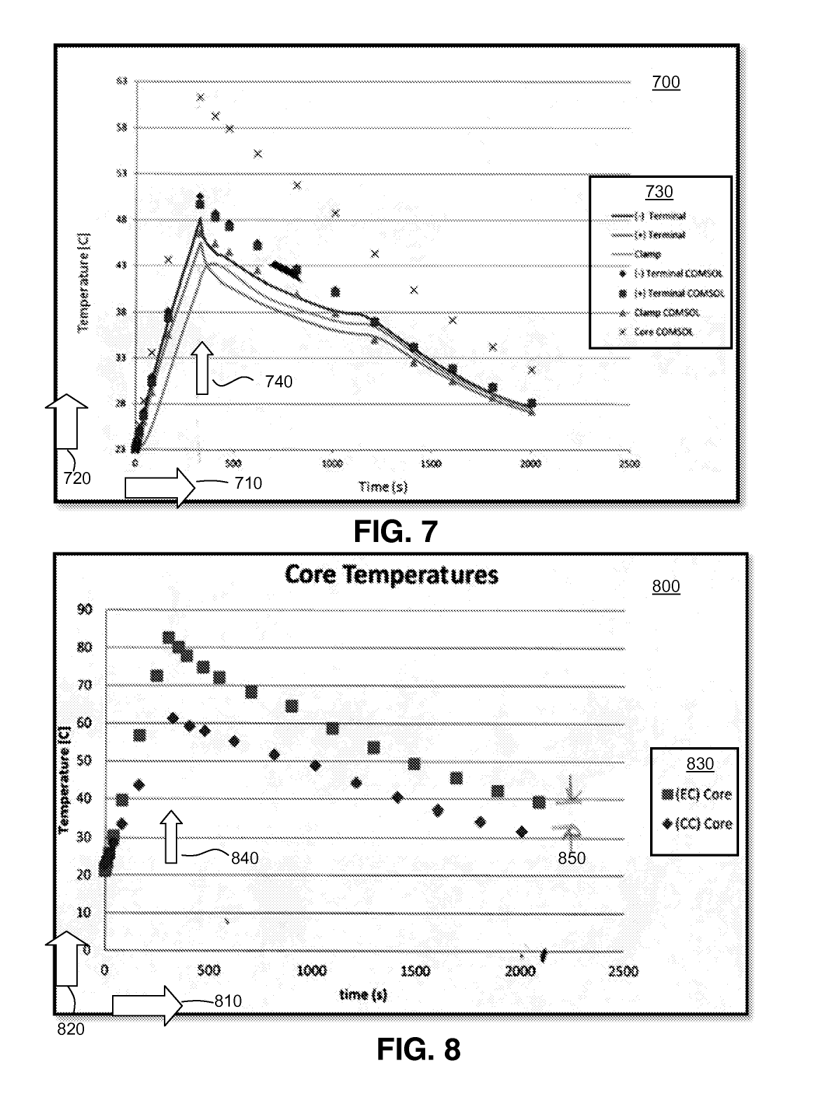

FIG. 7 shows a graphical view 700 of temperature response at specific locations of the battery assembly. Time in seconds represents the abscissa 710 and temperature in degrees Celsius represents the ordinate 720. A legend 730 identifies cathode and anode terminals, clamp, and values from thermocouples, all showing a trend that peaks at four minutes and then diminishes.

FIG. 8 shows a graphical view 800 of core temperatures. Time in seconds represents the abscissa 810 and core temperature in degrees Celsius represents the ordinate 820. A legend 830 identifies end-cooling core with points for end cooling 840 and core cooling 850 showing similar trends to view 700, peaking at about four minutes and diminishing gradually thereafter.

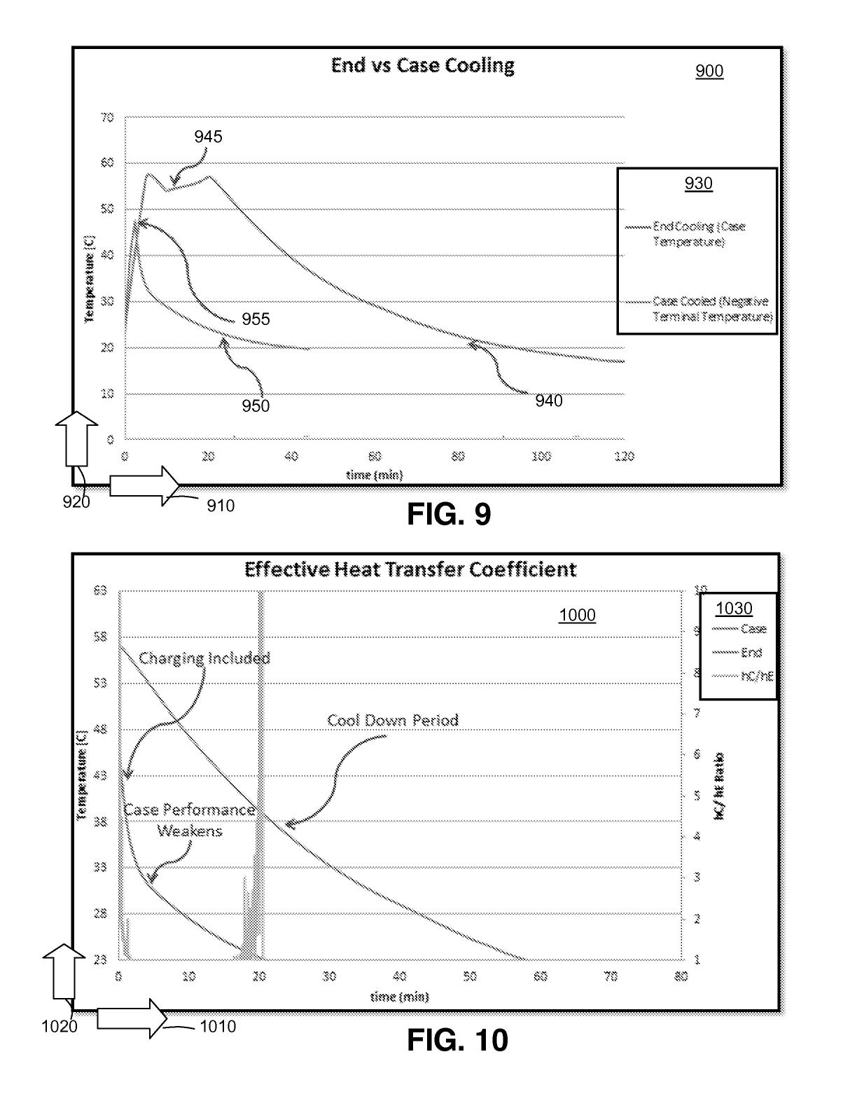

FIG. 9 shows a graphical view 900 comparing conventional end-cooling and case-cooling temperatures. Time from battery discharge in minutes represents the abscissa 910 and temperature in degrees Celsius represents the ordinate 920. A legend 930 identifies the plotted curves for end-cooling 940 with battery charge inflection 945, and case-cooling 950 with battery discharge peak 955 as conventional thermal management configurations.

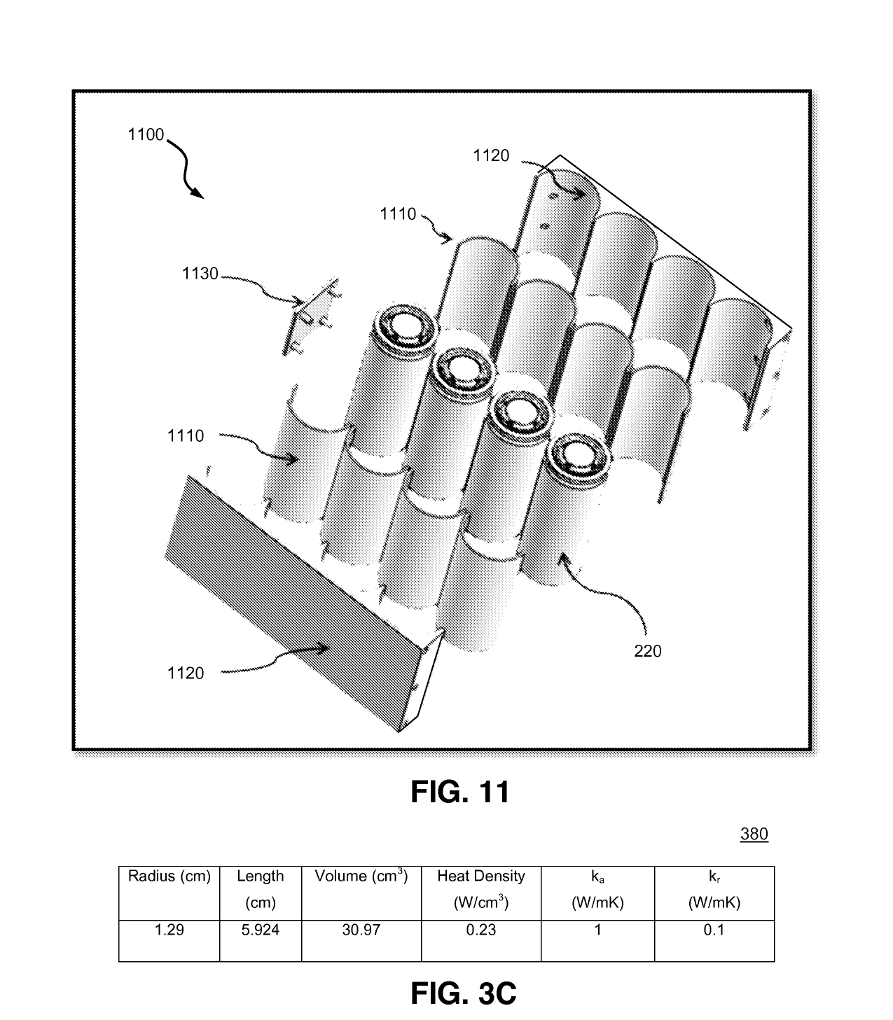

FIG. 10 shows a graphical view 1000 of effective heat transfer coefficient. Time in minutes represents the abscissa 1010, temperature in degrees Celsius represents the left ordinate 1020 and heat transfer coefficient represents the right ordinate 1030. A legend 1040 identifies the plotted curves for case-cooling 1050, end-cooling 1060 and case-to-end ratio h_{C}/h_{E} 1070. The cooling curves 1050 and 1060 diminish exponentially with time in relation to the left ordinate, whereas the coefficient ratio 870 shows a peak at about 20 minutes during the cool-down period in relation to the right ordinate.

The Table 1 values in view 380 are incorporated into eqns. 3 and 4 to produce a graph of temperature response. FIGS. 4 and 5 show respective graphical views 400 of heat generation and 500 of temperature response comparisons for end- and case-cooling. The variance between the maximum radial and axial temperature difference is driven by the large temperature difference sensitivity in the radial outward direction.

One major factor in heat transfer and heat generation is surface area, which is dependent logarithmically on the radial value and volume, which is dependent parabolically upon the value of the outward position in the radial direction. Therefore, from a conceptual standpoint, the radial cooling case is more effective on removing heat than the axial direction due to the shorter conduction pathways and larger surface area. To further compare the end-cooling method with the case-cooling method, a commercially written computational fluid dynamic and heat transfer program (the “model program”) was used to analyze and compare a three-dimensional transient with heat generation analysis.

The case-cooled model was drafted by computer aided design (CAD) and translated into a numerical model program for heat transfer analysis, with the geometry shown in view 600. The thermal properties were assigned to each part based off the material properties of each element. The battery core was simplified to be graphite with anisotropic thermal conductivity in the radial and axial directions. The other model parameters were based on mimicking a previous case-cooled experimental setup as best as possible. A seven-watt (7 W) volumetric heat generation condition was set to each battery core with five seconds on and one second off for five minutes, with a twenty-five minute cool-down. An adiabatic boundary condition was assigned to the model, except for the heat sink 640, which was set at a constant temperature boundary condition 645 of 23° C.

The temperature probes were placed on the positive and negative terminals, core and clamp on the battery that is furthest away from the heat sink. In order to more effectively compare both qualitative and quantitative temperature trends of both cases, the model was tuned to match the in-house experimental results of the case-cooled method. The tuning parameters were the interfacial contact pressures and asperities between the battery casing and the thermal gap pad.

Once the model program for the case-cooling was validated with experimental results, the same tuning parameters were also used on the end-cooling model. Both end-cooling and case-cooling models were run at the exact same heat generation times, with the same boundary conditions and same material properties. Thermal contour plots were obtained at three minutes, which is halfway within the heat generation period, and at thirty minutes, which is at the end of the cool-down period.

For the end-cooling method, the thermal contour plot at three minutes illustrates that each battery consists approximately of the same thermal gradients with each other, indicating poor active cooling during heat generation. Analyzing the thermal contour plot at thirty minutes illustrates that the battery furthest away from the heat sink is still holding a majority of the heat, signifying poor heat transfer through the ends. The analysis agrees with the analytical cooling comparison that the heat transfer in the axial direction is not favorable.

With respect to the model program's case-cooled method results, the thermal contour plot at three minutes illustrates varying thermal gradients throughout each battery, indicating that active cooling is taking place during heat generation. Exploring the thermal contour plot at thirty minutes illustrates drastically varying temperatures for each battery and most of the heat has been transferred out from the battery that is furthest away from the heat sink.

Comparing the core temperatures of the furthest battery away from the heat sink for both the case-cooled method and the end-cooled method shows a core temperature difference of 20° C. at the end of heating (five minutes) and a 10° C. temperature difference at the end of the cooling period, with the case-cooled method showing the cooler temperature. These temperature differences are significant in both staying below the maximum temperature the batteries can reach during a single discharge heating and also during a repetition discharge heating.

Analysis of the case-cooled method has indicated that it is the more desirable method to keep the core temperature below a critical temperature and cool-down at a faster rate than the end-cool method. With completion of the analytical cooling comparison as well as modeling and simulation cooling comparison, experimental trials were conducted.

Experimental trials were performed to validate the conceptual understanding and numerical models of the case and end-cooling methods. The experimental setup and procedures were performed carefully to compare the two methods under the same conditions. The cooling schemes were subjected to the same cooling temperatures, each encapsulated within insulation for an adiabatic boundary condition, and both were subjected to relatively the same discharge and charge powers. Initially, the batteries were discharged at seven watts (7 W) for five-second on and one second off for five minutes, then a slight period of cool-down, followed by battery charging at 1 W to 2 W for approximately nine minutes, then cool-down until temperatures have reached at least their initial temperatures.

A caveat concerning the case-cooling method is that the method for assembling their bodies together was with a potting method (as discussed below) and not the clamping style of the prior art. Also, the discharging time for the case-cooling method was only 50% of the end-cooling method due to unknown electrical resistances within the batteries; however, the heat load was the same.

Another difference between the two experiments was the location of the thermocouples on the battery furthest away from the heat sink. The methods on how the batteries are fixed impeded repeatable thermocouple locations for both methods. The case-cooling method had the thermocouple fixed to the negative axial end of the battery, while the end-cooling method had the thermocouple fixed to the midsection of the battery on the radial casing. The location variations were thought to produce similar time dependent temperature responses and not affect the scope of the experiments.

After running the experiments, the data were compared and heat transfer computations were completed. As illustrated in graphical view 700, the sharp temperature peak corresponding to the case-cooled method is precisely when the discharging of the batteries ceases, whereas the blunt temperature peak for the end-cooling method occurred 45 seconds post discharging. The differences between the two temperature peaks signify that active cooling is occurring in the case-cooled method and not in the end-cooling method.

Also, investigating the event where the battery charge occurs, the end-cooling method observes a temperature increase, where the case-cooling method does not show any indication of the small heat load produced by the battery. The end goal of the battery cooling scheme is to effectively cool-down the batteries to a desired temperature after being subject to discharge and charge heat loads within a half hour time period. The results indicate that the case-cooled method would be the more adequate of the two methods. The cool-down time to reach the initial temperature for the case-cooling method was 23 minutes, where the end-cooling method takes 1 hour and 17 minutes, approximately three times longer than the case-cooling method; however, the case-cooling method was discharged for a lesser time.

Metrics, other than observing the temperature trends of the two cooling methods, such as cooling performance, are important due to the differences within the experiments. An effective heat transfer coefficient analogy was used to observe the cooling performance between the two methods. The lump sum method was used in determining the heat transfer coefficient h of the different cooling methods. The heat transfer coefficient is determined by observing the transient temperature dT/dt on a lump sum of mass m with surface area A_{S} at an initial temperature submerged into a medium at a temperature T_{∞} shown in eqns. 5 and 6. Case and end-cooling configurations can be compared by the ratio of their heat transfer coefficients.

$$\begin{matrix}h = \frac{- m \frac{d T}{d t}}{{A}_{S} ( T - {T}_{∞} )} , & ( 5 ) \\ \frac{{h}_{C}}{{h}_{E}} = \frac{{A}_{SE} ( {T}_{E} - {T}_{∞} ) \frac{d {T}_{C}}{d t}}{{A}_{SC} ( {T}_{C} - {T}_{∞} ) \frac{d {T}_{E}}{d t}} . & ( 6 )\end{matrix}$$

Within the two methods used, the batteries are not directly submerged into a medium and do not cool uniformly, which can pose issues with using the lump sum method. Although the lump sum method is not accurate, it will, however, show qualitatively, which cooling method has the greater performance. The cylindrical surface area of the battery was used as the surface area A_{SC} for the case-cooled method and the end cap surface area of the battery was used as the surface area A_{SE} for the end-cooling method. Numerical differentiation was used to determine the transient temperature sensitivities for both cooling temperature profiles during the cool-down period.

Observing the effective heat transfer coefficient ratio of both cooling methods, the case-cooled method is shown to perform greater than the end-cooled method. Observing the experimental transient temperature profiles and cooling performances derived from the effective heat transfer coefficients of both cooling methods, the case-cooling method outperformed the end-cooling method in active cooling, overall cool-down time, and cooling performance.

The case-cooling method was chosen as it proved analytically, computationally and experimentally superior in effectively removing heat generated within a battery. The clamping design of the case-cooling method, as described above, can be difficult to manufacture and assemble. Moreover, the clamping design can result in contact pressure between the clamps and batteries being non-uniform, especially at the center portion where the clamps are not fixed. The contact pressure relief can yield in poor thermal performance of the system due to more probably air asperities.

To that objective, one aspect of various exemplary embodiments relates to a potting method that securely encapsulates the batteries within a thermally conductive block with a thermally conductive and electrically insulating epoxy. FIG. 11 shows an isometric exploded view 1100 of components for an exemplary potted battery case. The set of four batteries 220 are sandwiched by corresponding hemispherical sets aluminum sheet layers 1110 with Kapton. A pair of bilateral case halves 1120 flanks the layers 1110, which are held together by an end plate 1130. Alternatively, the bilateral halves 1120 can be replaced by a unitary block with through-holes into which the batteries 220 can be inserted.

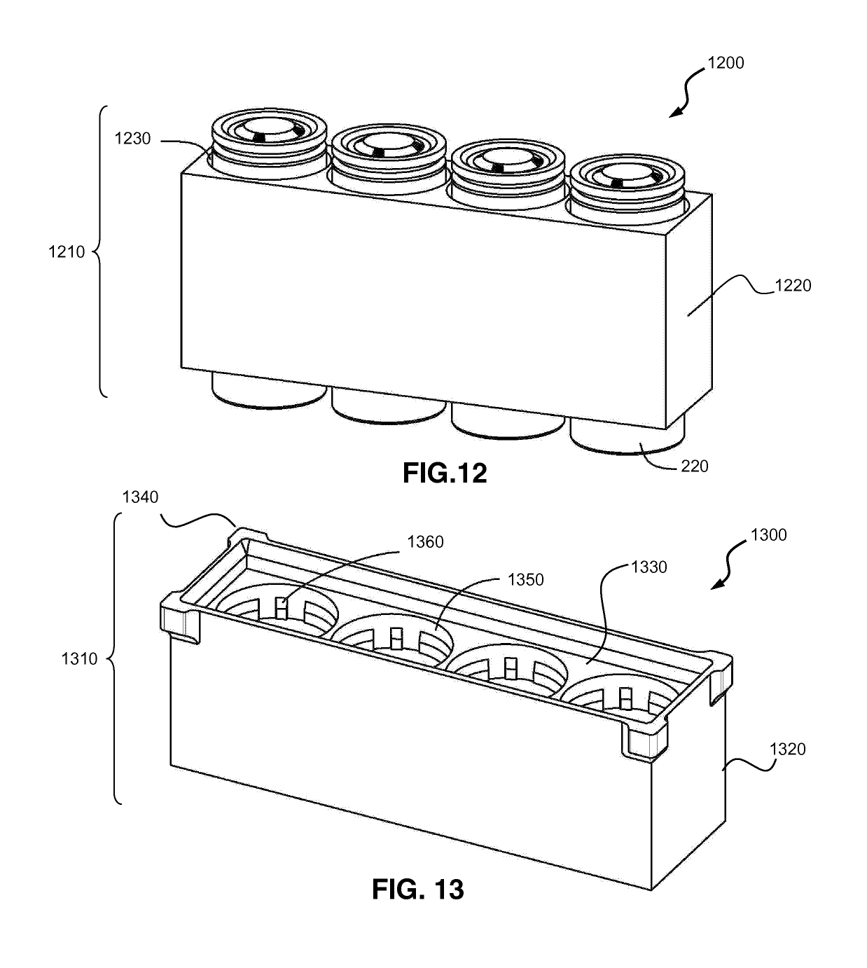

FIG. 12 shows an isometric assembly view 1200 of the exemplary potted battery case 1210. The batteries 220 can be encapsulated within a thermally conductive block or housing 1220. The process for fabricating the housing 1220 requires fewer steps than the clamping method, described above. To make the housing 1220, one mills a block of thermally conductive material, such as aluminum, and then bores holes 1230 therein for the batteries 220. The holes 1230 can be machined with standard sized drill bits, and surface condition is not a consideration.

To that end, increasing the surface roughness of the holes 1230 may be beneficial for bonding to thermal epoxy that is disposed between the batteries 220 and the inside surface of the holes 1230 to fill all asperities without any need for contact pressure. This means that the thermally conductive block 1220 can be formed of a lesser aluminum alloy (as compared with the conventional clamping method in view 1100) with improved thermal performance.

FIG. 13 shows an isometric view 1300 of a thermal fixture or mold 1310. A rectangular frame 1320 has an enclosed face and an exposed face 1330, the latter with corner extensions 1340 and cups 1350 to receive a corresponding battery 220 in the case 1210. Each cup 1350 includes epoxy vents 1360.

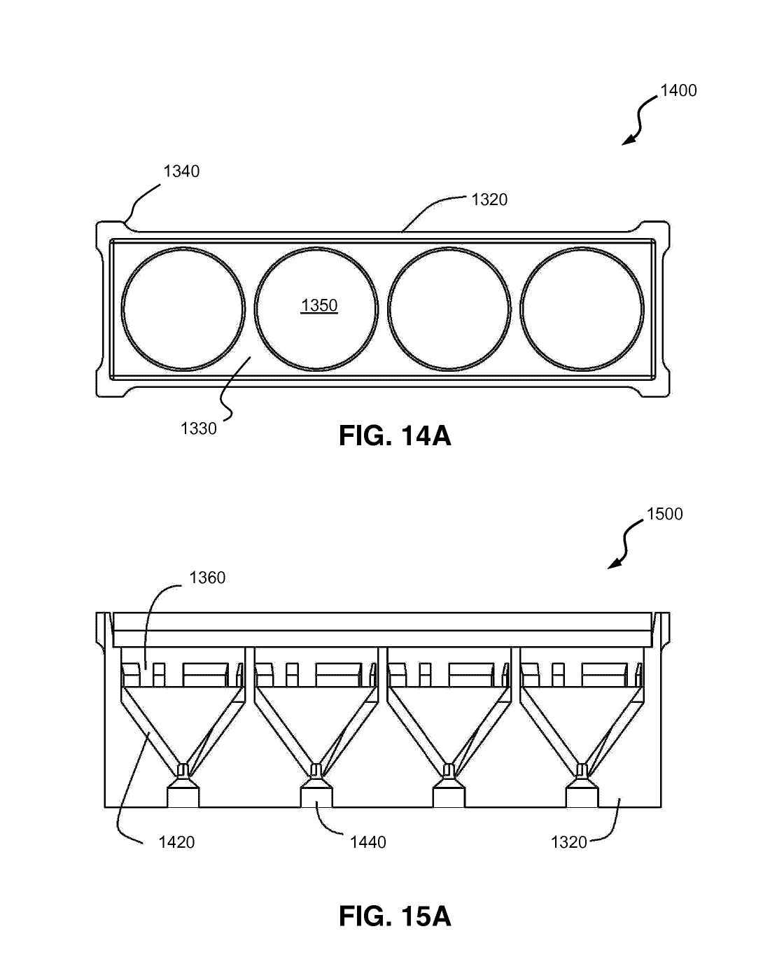

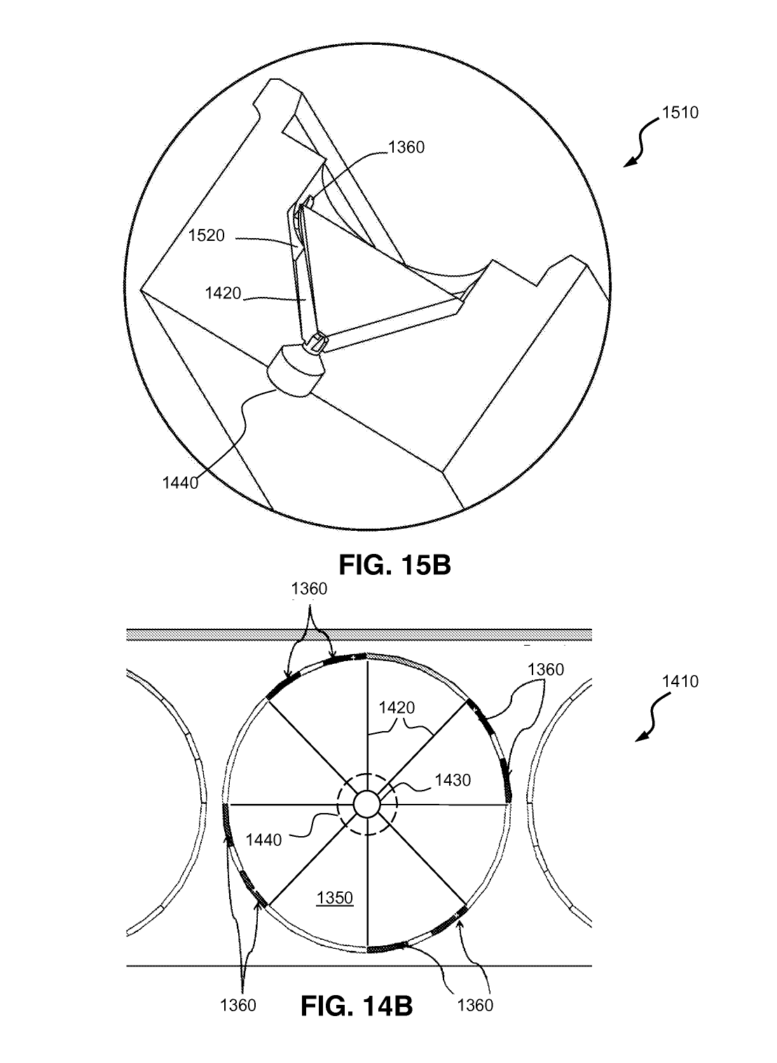

FIG. 14A shows a plan view 1400 of the mold 1310 from the exposed face 1330. FIG. 14B shows a detail plan view 1410 of the mold 1310. Connected to each epoxy vent 1360 are channels 1420 that feed epoxy through a central manifold 1430. An epoxy injection port 1440 on the enclosed face supplies the epoxy through the manifold 1430 and the channels 1420 to encase the batteries 220 after assembly. The port 1440, manifold 1430, channel 1420 and the vent 1360 constitute an epoxy network.

FIG. 15A shows an elevation cross-section view 1500 of the thermal mold 1310. The FIG. 15B shows a detail isometric view 1510 of the epoxy network. The thermally conductive epoxy enters through the injection port 1440 into the manifold 1430 and through the channels 1420. The epoxy passes into an exit chamber 1520 and through the vent 1360.

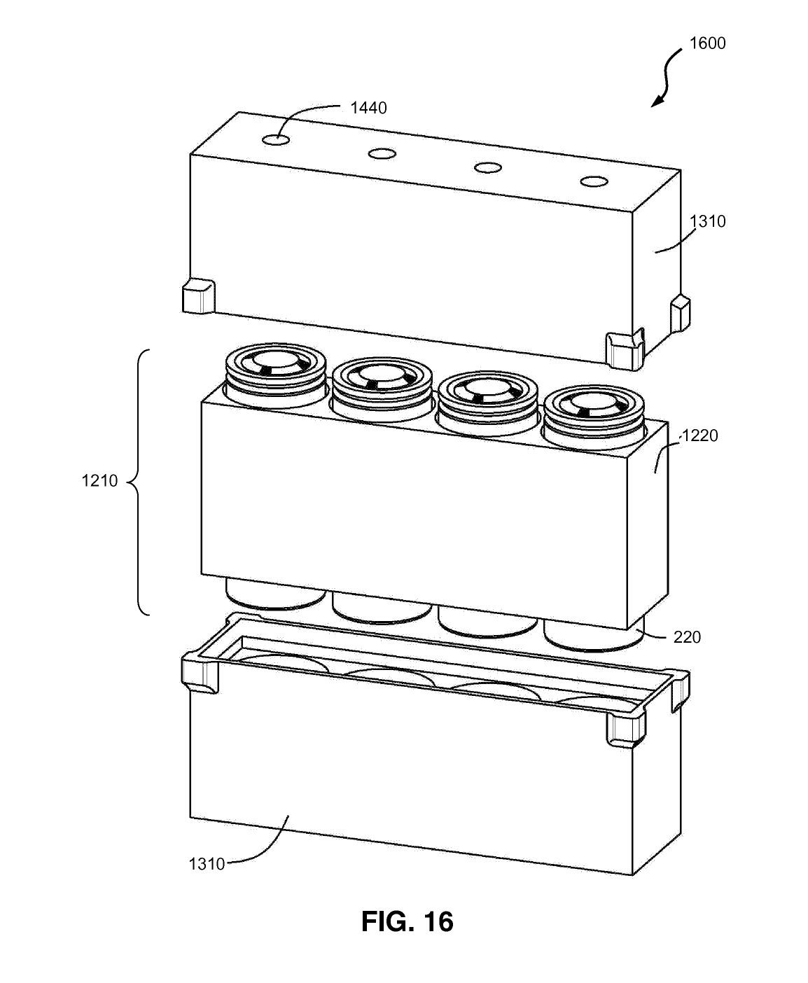

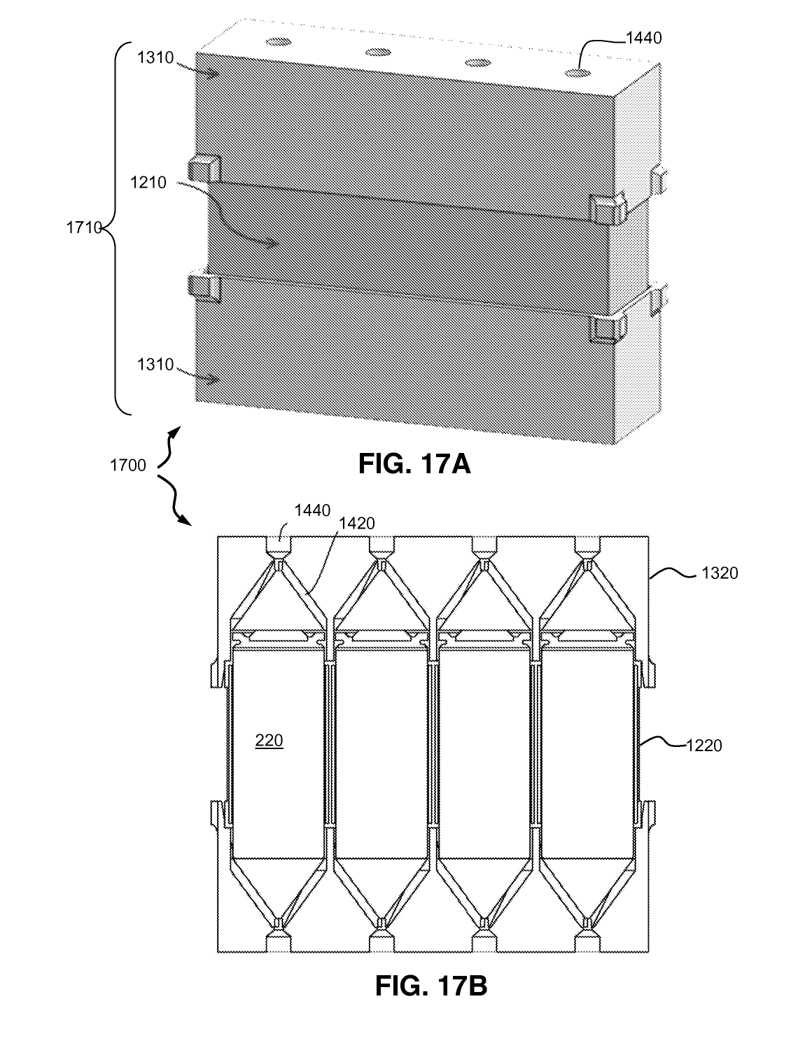

FIG. 16 shows an isometric exploded view 1600 of the battery case 1210 sandwiched between upper and lower molds 1310. FIGS. 17A and 17B respectively show isometric and elevation assembly views 1700 of an exemplary fixture-case assembly 1710. The ports 1440 provide access above and below the assembly 1710 for epoxy to be injected into the molds 1310.

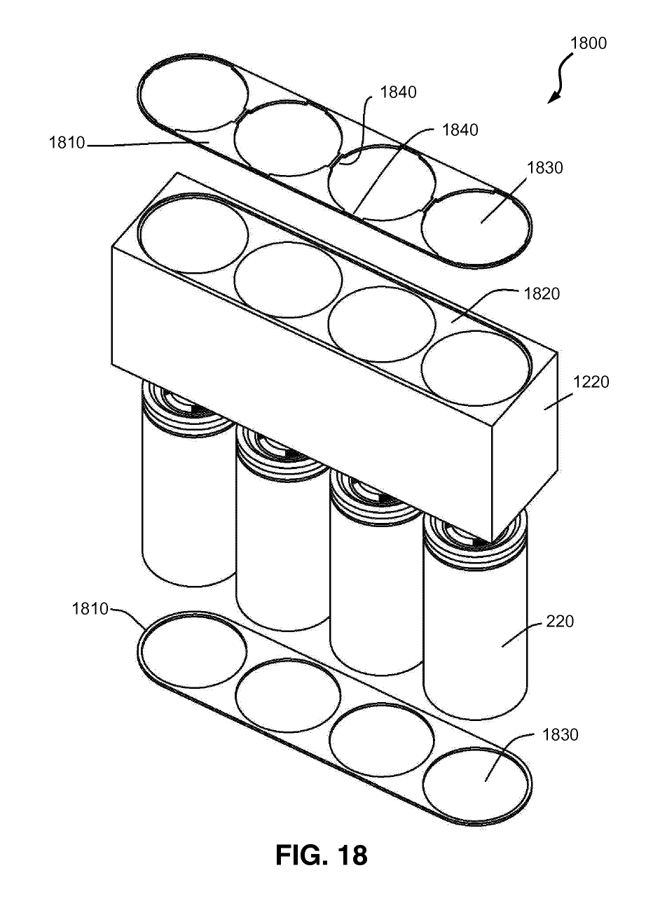

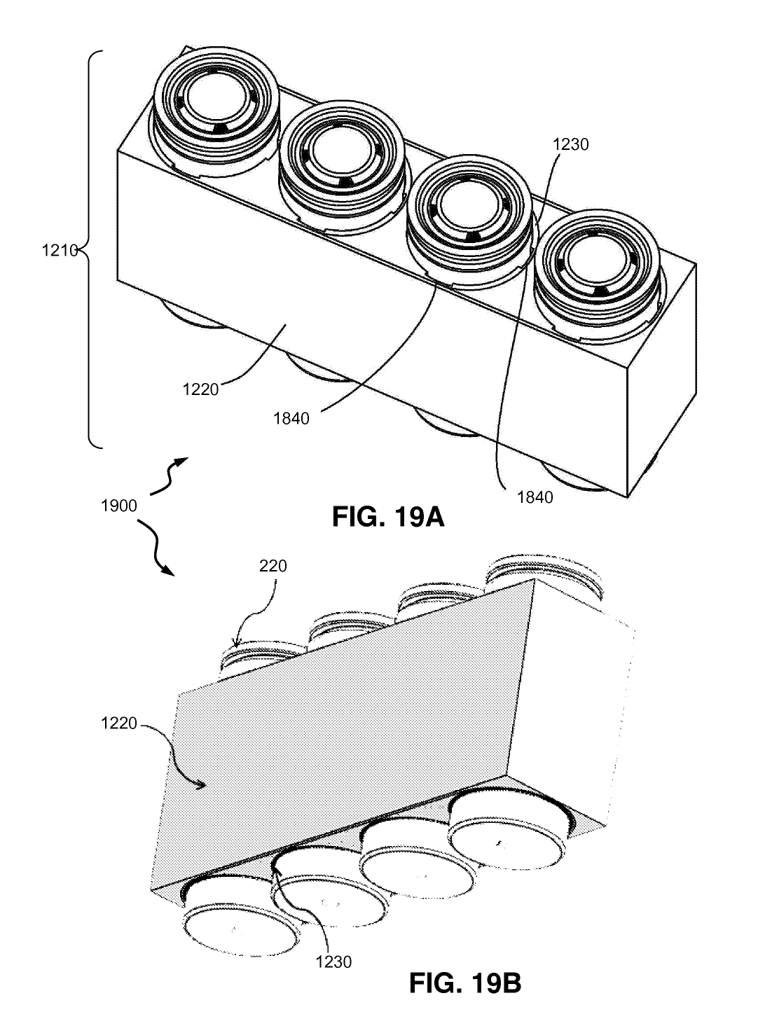

FIG. 18 shows an alternative configuration with an isometric exploded view 1800 of components of the housing 1220. Top and bottom gaskets 1810 can be inserted onto axial recesses 1820 of the housing 1220. The gaskets 1810 include a series of four circular cutouts 1830 corresponding to the batteries 220. The cutouts 1830 include notches 1840 on their peripheries for receiving adhesive (e.g., epoxy) as peripheral injection ports. FIGS. 19A and 19B show isometric assembly views 1900 of the housing 1210 with batteries 220 installed, respectively upper and lower perspectives. The notches 1840 in the gaskets 1810 are shown within the holes 1230 for receiving the batteries 220 in the housing 1220.

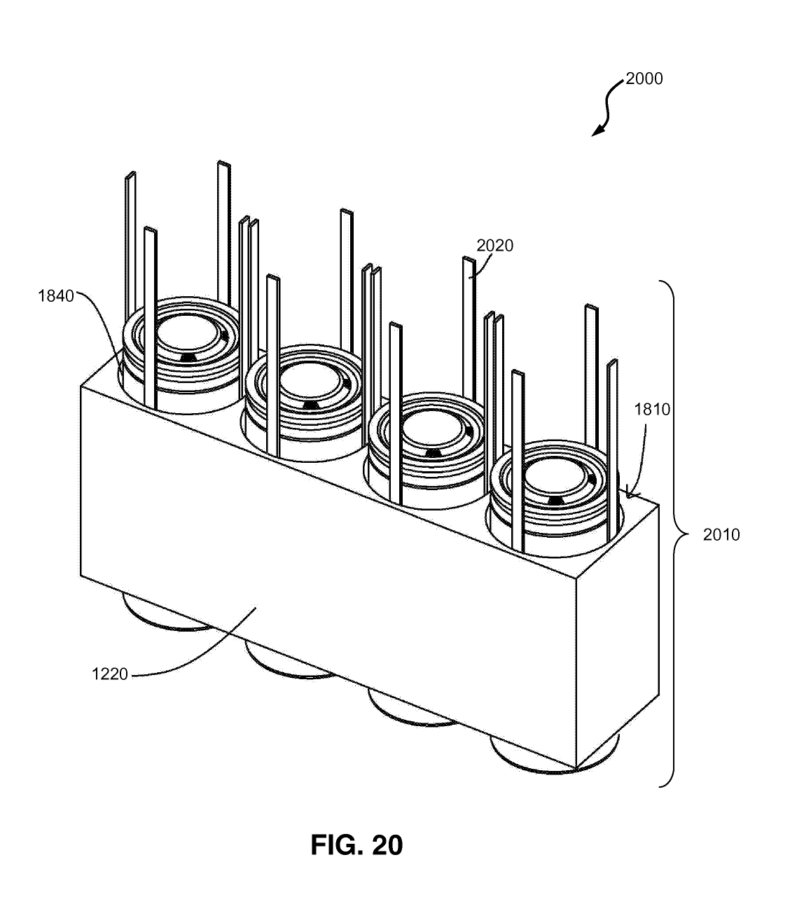

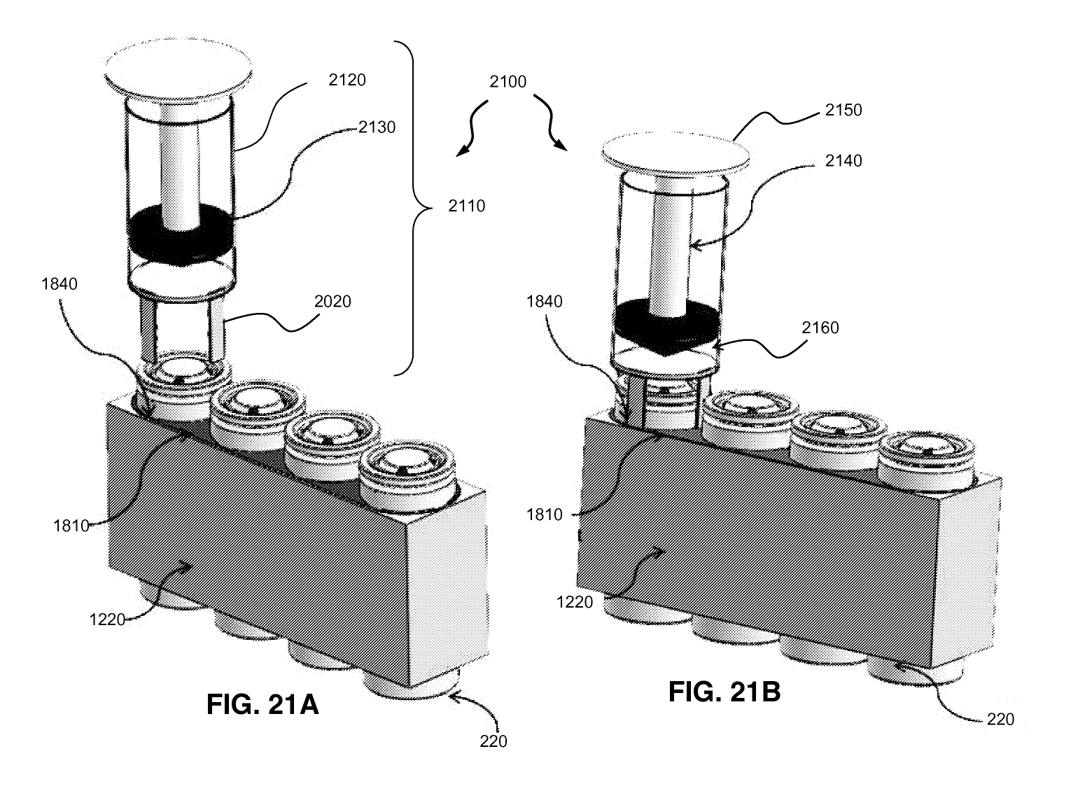

FIG. 20 shows another alternative isometric assembly view 2000 of the battery case 1210 as an alignment assembly 2010 with alignment shims 2020 corresponding to the injection notches 1840 in the gaskets 1810. FIGS. 21A and 21B similarly show isometric views 2100 of an injection mechanism 2110 for inserting adhesive into the case 1210. The removable mechanism 2110 includes an epoxy chamber 2120 with the shims 2020 extending axially therefrom into the notches 1840. The chamber 2120 includes a plunger 2130 to push the adhesive into the shims 2020. The plunger 2130 connects to a pushrod 2140, which in turn connects to an actuator 2150 (manual handle or other interface) for ejecting thermal epoxy 2160 contained in the chamber 2120.

In order to pot the batteries 220 within the thermally conductive housing 1220, a special fixture or mold 1310 can be used. Referring to FIG. 12 through FIG. 17B, the mold 1310 can securely hold the batteries 220 such that they are all concentric to their associated bored holes within the housing 1220 while enabling access for injected epoxy 2160 to flow in between the batteries 220 and the holes 1230 and retaining the epoxy in place until it hardens. The mold 1310 can include a plurality of cups 1320, one for each battery 220, the cups 1320 seating each battery to be concentric with the battery's associated hole 1230. Typically, the maximum diameter of the cup 1320 and the diameter of the bored hole 1230 will be congruent with one another. The cup 1320 then tapers down to a diameter such to create an interference fit between the cup 1320 and the battery 220 when the mold 1310 is disposed on the housing 1220, as shown in FIG. 17B. The taper serves to effectively center the battery 220 during the action of the interference fit.

Each cup 1320 includes a plurality of channels 1520 and vents 1330 to enable the thermal epoxy 2160 to flow in from the top of the mold 1310 and evenly distributed around the full circumference of the batteries 220, as shown in FIG. 17B, for example. An opening thickness of the vents 1330 can be the difference between the maximum and minimum diameters of the cup 1320. The mold concept was designed to sandwich a case-cooled battery pack 1610 in between two molds 1310 to seal the thermal epoxy 2160 from escaping the molds 1310 until sufficiently hardened.

In an exemplary embodiment, the mold 1310 was fabricated using acrylonitrile butadiene styrene (ABS) additive manufacturing processes from a commercial printer. Additive manufacturing was used for the construction process due to quick turnaround times for prototyping and the ability to create trivial geometries that conventional manufacturing processes cannot easily duplicate. The incline angle of epoxy channel 1520 incline angle shown in view 1500 was chosen for the purpose of manufacturability, as the subsequent printed layer must be able to adhere to the preceding printed layer. It should be understood, however, that other manufacturing techniques and other materials and design variations are contemplated within the scope of the present invention.

After prototyping the molds 1310, a set of these were used to pot the batteries 220 within the housing 1220. The batteries 220 were disposed into the housing 1220 sandwiched by the molds 1310, as shown in FIG. 17B. The thermal epoxy 2160 was injected from both top and bottom injection ports 1530 of both molds 1310. The bottom injection port 1530 was then closed off and the resulting assembly was placed into an oven to accelerate the hardening process of the thermal epoxy 2160. The molds 1310 were removed after epoxy-curing and electrical tabs were electrically attached to terminals of the batteries 220 to create a finished product.

Using sacrificial molds, such as molds 1310 described above, fabricated by additive manufacturing can cause difficulty in a production type setting. To that end, in an alternative embodiment of the present invention, as shown in FIG. 18 through FIG. 19B, upper and lower gaskets 1810 can be seated into machined recesses 1820 at each axial face of the thermally conductive housing 1220. The gaskets 1810 can include an opening 1830 to concentrically retain the batteries 220 in the holes 1230 of the housing 1220. The lower gasket 1810 can fit completely about the outer periphery of the batteries 220, thus preventing the escape of thermal epoxy 2160 disposed between the batteries 220 and the holes 1230. The upper gasket 1810 can include injection notches 1840 disposed about the outer periphery of the opening 1830 to permit injection of the thermal epoxy therein.

An injection mechanism 2110 can be used to inject the thermal epoxy into the injection notches 1840. The injection mechanism 1860 can include a plurality of shims 2020 that fit into each of the injection notches 1840 about the battery 220. Depressing the plunger 2130 of the injection mechanism 2110 can push the thermal epoxy into the region between the battery 220 and hole 1230 of the housing 1220 that receives the battery 220 therein.

Alternatively in view 1900, the integrated gaskets 1810 can be replaced by a plurality of gasket rings disposed individually about each of the batteries 220 centered around each of the holes 1230. In some embodiments, the gasket on the bottom of the housing 1220 about each of the batteries 220 can be formed without injection ports, thereby preventing the thermal epoxy from escaping out the bottom before hardening.

Referring to view 2000, a plurality of shims 2020 can be seated into each hole 1230 in the thermally conductive housing 1220. The shims 2020 can run axially relative to the battery 220 and creates a standoff from the battery casing to the hole 1230, keeping the battery 220 concentrically aligned to the hole 1230. The shims 2020 can be made of any material that is able to conform to the radius of both the battery 220 and bored hole 1230. A bottom seal (not shown) may be deployed to retain the thermal epoxy that is introduced into the notch 1840 between the battery 220 and the hole 1230. An injection mechanism, such as injection mechanism 2110 as described, may be used to introduce the thermal epoxy into the hole 1230. In some embodiments, once the thermal epoxy hardens, the shims 2020 may be trimmed flush with the housing 1220.

While certain features of the embodiments of the invention have been illustrated as described herein, many modifications, substitutions, changes and equivalents will now occur to those skilled in the art. Artisans of ordinary skill will understand that the appended claims are intended to cover all such modifications and changes as fall within the true spirit of the embodiments.

1. A battery fixture for thermal management of a plurality of electrical batteries, said fixture comprising:
a thermally conductive housing;
a plurality of holes formed through said thermally conductive housing, said plurality of holes sized larger than the plurality of batteries disposed therein;
a spacing member concentrically disposing each battery of the plurality of batteries in a respective hole of said plurality of holes; and
thermally conductive adhesive disposed between an inner surface of said plurality of holes and an outer surface of the plurality of batteries.

2. The battery fixture of claim 1, wherein a portion of the plurality of batteries extend beyond each end of said plurality of holes.

3. The battery fixture of claim 2, wherein said spacing member includes a pair of molds that fit on top bottom sides of said thermally conductive housing.

4. The battery fixture of claim 3, wherein each mold of said pair includes a plurality of cups, each cup corresponding to said battery of the plurality of batteries and extending beyond said each hole of said plurality of holes.

5. The battery fixture of claim 4, wherein said each cup is tapered from a first diameter to a second diameter, wherein the plurality of batteries produces an interference fit to said plurality of cups, and said second diameter is smaller than said first diameter.

6. The battery fixture of claim 5, wherein said first diameter is equal to a diameter of said plurality of holes.

7. The battery fixture of claim 4, further comprising a plurality of vents and a plurality of channels formed in said plurality of cups of said molds.

8. The battery fixture of claim 2, wherein said spacing member includes upper lower gaskets encompassing said plurality of holes.

9. The battery fixture of claim 8, further comprising first and second recesses formed in opposite sides of said thermally conductive housing, said recesses disposed around each of said plurality of holes and respectively receiving said upper and lower gaskets.

10. The battery fixture of claim 8, further comprising injection ports formed in at least one of said upper and lower gaskets, said injection ports permitting fluid access to a space formed between said inner surface of said plurality of holes said outer surface of the plurality of batteries, said fluid constituting epoxy.

11. The battery fixture of claim 8, wherein one of said upper gasket includes said injection ports and said lower gasket fits closely about said outer surface of the plurality of batteries.

12. The battery fixture of claim 2, wherein said spacing member includes upper gasket rings and lower gasket rings individually fitting about the plurality of batteries at distal ends of said plurality of holes.

13. The battery fixture of claim 12, further comprising injection ports formed in at least one of said upper and lower gasket rings, said injection ports permitting fluid access to a space formed between said inner surface of said plurality of holes and said outer surface of the plurality of batteries.

14. The battery fixture of claim 12, wherein one of said upper gasket rings includes said injection ports and said lower gasket rings fits closely about said outer surface of the plurality of batteries.

15. The battery fixture of claim 2, wherein said spacing member includes a plurality of shims disposed between said outer surface of the plurality of batteries and said inner surface of said plurality of holes.

16. A method for cooling a plurality of electrical batteries, said method comprising:
centering, with a spacing member, a plurality of batteries in a plurality of holes formed through a thermally conductive housing; and
filling a space formed between said inner surface of the plurality of holes and said outer surface of the batteries with a thermal epoxy.

17. The method of claim 16, wherein the spacing member includes molds fitting on top and bottom sides of said thermal conductive housing.

18. The method of claim 16, wherein said spacing member includes upper and lower gaskets that fit about a portion of the plurality of batteries that extends beyond each end of said plurality of holes.

19. The method of claim 16, wherein said spacing member includes upper and lower gasket rings individually fitting about the plurality of batteries at distal ends of said plurality of holes.

20. The method of claim 16, wherein said spacing member includes a plurality of shims disposed between said outer surface of the plurality of batteries and said inner surface of said plurality of holes.
